(19) United States
(12) Patent Application Publication
(10) Pub. No.: US 2026/0117912 A1
(43) Pub. Date: Apr. 30, 2026

(54) TUBING COMPONENTS AND METHOD OF MAKING TUBING COMPONENTS

(71) Applicant: University of Florida Research Foundation, Inc., Gainesville, FL (US)

(72) Inventors: James Arthur Trainham, Gainesville, FL (US); Jonathan Scheffe, Gainesville, FL (US); Bruce A. Cook, Gainesville, FL (US)

(21) Appl. No.: 19/369,693

(22) Filed: Oct. 27, 2025

Related U.S. Application Data
(60) Provisional application No. 63/712,584, filed on Oct. 28, 2024.

(51) Int. Cl. F16L 58/08; B22F 10/28; B33Y 10/00; B33Y 70/00; F16L 9/02

(52) U.S. Cl. CPC F16L 58/08; B22F 10/28; F16L 9/02; B22F 2301/20; B22F 2303/30; B33Y 10/00; B33Y 70/00

(57) ABSTRACT

The present disclosure provides for tubing components that include an inner tube wall (e.g., Mo), an inner coating and an outer coating (e.g., MoSiB and/or SiO₂Bₓ), methods of making tubing components, and the like.

### CROSS-REFERENCE TO RELATED APPLICATIONS

This application claims the benefit of U.S. Provisional Application entitled TUBING COMPONENTS AND METHOD OF MAKING TUBING COMPONENTS” and having Ser. No. 63/712,584, filed Oct. 28, 2024, which is herein incorporated by reference in its entirety.

### BACKGROUND

Current technologies are not ideal for withstanding the rigors associated with extreme temperatures and temperature fluctuations such as the operation in a solar collection energy storage. Thus, there is a need to address these challenges as well as others.

### SUMMARY

The present disclosure provides for tubing components that include an inner tube wall (e.g., Mo), an inner coating and an outer coating (e.g., MoSiB and/or SiO₂Bₓ), methods of making tubing components, and the like.

The present disclosure provides for a tubing component, wherein the tubing component comprises a Mo tube wall having an inner coating on the inside of the Mo tube and an outer coating on the outside of the Mo tube, wherein the inner coating comprises a MoSiB inner coating, wherein the outer coating includes a MoSiB outer coating. In an aspect, the Mo tube wall as a thickness of about 1 to 10 mm, wherein the inner coating has a thickness of about 10 to 150 μm, wherein the outer coating has a thickness of about 3 mm to 500 mm. In an aspect, the inner coating further comprises a SiO₂Bₓ inner coating, wherein is x<1 weight %, wherein the MoSiB inner coating has a first side and a second side, wherein the first side of the MoSiB inner coating is bonded to the inside of the Mo tube and the SiO₂Bₓ inner coating is bonded to the second side of the MoSiB inner coating so that the SiO₂Bₓ inner coating is the inner most layer of the tubing component; and wherein the outer coating further comprises a SiO₂Bₓ outer coating, wherein is x is <1 wt. %, wherein the MoSiB outer coating has a first side and a second side, wherein the first side of the MoSiB outer coating is bonded to the outside of the Mo tube and the SiO₂Bₓ outer coating is bonded to the second side of the MoSiB outer coating so that the SiO₂Bₓ outer coating is the outer most layer of the tubing component. In an aspect, the MoSiB inner coating has a thickness of about 10 to 100 microns, wherein the MoSiB outer coating has a thickness of about 10 to 100 microns, wherein the SiO₂Bₓ inner coating has a thickness of about 5 to 20 microns, wherein the SiO₂Bₓ outer coating has a thickness of about 5 to 20 microns. In an aspect, the length of the tubing component about 10 mm to 6 m, about 100 mm to 1 m, about 1000 mm to 1 m. In an aspect, the tubing component can be straight or can be a union, an elbow, coupling, or a valve.

The present disclosure provides for a method of making a tubing component, comprising: a) disposing a first material in a first area, wherein the first material is a precursor material to form Mo; b) disposing a second material in a second area, wherein the first area and second area are adjacent another, wherein the second material is a precursor to form MoSiB; c) disposing a third material in a third area, wherein the third area is on a side opposite the second area, wherein the third material is a precursor to form MoSiB, wherein the first area, the second area, and the third area form a cross-section for a first layer of the tubing component, wherein the second area is on an inner side of the first layer of the tubing component, wherein the third area is on an outer side of the first layer of the tubing component; d) irradiating the first layer to form a first Mo tube wall layer, an inner coating layer, and an outer coating layer, wherein the inner coating layer is on the inside of the Mo tube layer and an outer coating layer is on the outside of the Mo tube layer, wherein the inner coating layer comprises a MoSiB inner coating layer, wherein the outer coating includes a MoSiB outer coating layer; and e) repeating steps a) to c) to form the tubing component.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates a cross section of coated surface of a receiver tube wall with Mo—Si—B coating (═SiO₂Bₓ outer layer+composite middle layer); and refractory metal, such as Mo (substrate). All substrate surfaces exposed to air will be coated (e.g., inner and outer walls of absorber tubes). FIGURE not to scale.

### DETAILED DESCRIPTION

The present disclosure provides for tubing components that include an inner tube wall (e.g., Mo), an inner coating, and an outer coating (e.g., MoSiB and/or SiO₂Bₓ), methods of making tubing components, and the like.

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of material science, chemistry, physics, and the like, which are within the skill of the art. Such techniques are explained fully in the literature.

Prior to describing the various embodiments, the following definitions are provided and should be used unless otherwise indicated.

Unless otherwise defined, all technical and scientific terms used herein have the same meaning as commonly understood by one of ordinary skill in the art of material science, chemistry, physics, and the like. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DISCUSSION

The present disclosure provides for tubing components that include an inner tube wall (e.g., Mo), an inner coating and an outer coating (e.g., MoSiB and/or SiO₂Bₓ), methods of making tubing components, and the like. Embodiments of the present disclosure provide for tubing components that can withstand the rigors (e.g., extreme temperatures, temperature fluctuation, in ambient air, and the like) of operation in a solar collection energy storage, energy conversion or chemical conversion system, hydrocarbon processing, and the like. In addition to tubing components, other components (e.g., heat exchanger, pump, and the like) that are exposed to extreme conditions can also be made of using embodiments of the present disclosure.

Mo would be an ideal CSP receiver material, given its retention of mechanical strength and resistance to creep at temperatures exceeding that of the Ni-based superalloys. At 1000° C., Mo offers high thermal conductivity, good machinability, and reasonable cost because Mo has a tensile strength exceeding 165 MPa which is well above the desired 25 MPa for the supercritical CO₂ (sCO₂) Brayton cycle. What has prevented the use of refractory metals is their tendency to oxidize at relatively low temperatures despite having melting points that exceed 2000° C. For example, Mo exhibits accelerated oxidation in air at temperatures as low as 400° C. and 425° C. for tantalum. The present disclosure enables the inner and outer surfaces of the Mo tube wall to be coated with materials to protect the Mo tube wall.

In an aspect, the tubing component can be made using additive manufacturing so that the tubing component is made in a layer-by-layer manner, which overcome limitations presented with forming an inner coating for a tubing component. The tubing component can include various types of components such as union, an elbow, coupling, or a valve as well as longer tubing components (e.g., about 10 mm to 10 m or longer, about 100 mm to 5 m, about 1 cm to 1 m, about 10 cm to 1 m, about 100 cm to 2 m). In an aspect, the tubing components are stable a high temperature (e.g., about 700° C. to 1650° C., about 700° C. to 1300° C., or higher than 1650° C.), have the characteristic of handling sCO₂, (e.g., SCO₂ is at a temperature of about 700° C. to 1300° C. or more), and/or has a tensile strength of about 100 Mpa to 140 Mpa at 1200° C. In addition, the tubing component exhibits long-term stability in air, enable thousands of thermal cycles to be run, is made of a base refractory metal (e.g., Mo) functioning as a low-emissivity IR reflector, has a self-healing cermet coating (e.g., MoSiB), and has the antireflection oxidation-resistant borosilicate outer layer that acts as an efficient absorber in the visible spectrum.

In an aspect, the tubing component can include a Mo tube wall having a MoSiB inner coating and an MoSiB outer coating. In addition, the tubing component can include a SiO₂Bₓ inner coating (x<1 weight %, x is greater than 0 (e.g., x can be 0.01 to 0.99 weight %)) on the MoSiB inner coating and a SiO₂Bₓ outer coating on the MoSiB outer coating. The tubing component (e.g., with an Mo tube wall) including the MoSiB inner coating and an MoSiB outer coating (as well as the SiO₂Bₓ inner coating and the SiO₂Bₓ outer coating) can have excellent high-temperature properties: 1) high strength; 2) creep and fatigue resistance; 3) oxidation, corrosion and erosion resistance in air and exposure to the various types of material (e.g., molten material) that can be used. The MoSiB present in MoSiB inner and outer coating a nominal chemical stoichiometry Mo_{0.46}Si_{0.35}B_{0.19} and has three distinct phases, Mo₅Si₃, MoSi₂ and MoB. The MoSiB composite coating can have a thickness of about 20 to 150 microns, about 50 to 150 microns, about 100 to 500 microns, about 20 to 100 microns, or about 50 to 100 microns. The high-temperature oxidation resistance of Mo—Si—B alloys results from the formation of a dense borosilicate glass layer. During the initial state of oxidation the formation of volatile MoO₃ is accompanied by the simultaneous oxidation of Si and B to form a borosilicate scale that can possess a varying amount of boron (SiO₂Bₓ). The properties of the scale depend on the B to Si ratio of the alloy that determines its viscosity. Small additions of boron to Mo₅Si₃ promote the formation of a non-porous, protective scale that leads to steady-state oxidation so that small ratios of B to Si are preferred. The growth of the borosilicate scale during steady-state oxidation proceeds through the inward diffusion of oxygen.

Coating methods applicable to the inner surface of tubes are quite limited due to the geometrical restriction. Historically, the maximum depth to which a uniform coating can be applied is equal to the diameter of the tube. Applying a uniform coating to the interior surface of piping and tubing been a long-standing problem. The present disclosure provides for methods of fabricating a complete tubing component and coating system together at the point of manufacturing. The economic and societal benefits of such a technological advancement would clearly be cross-cutting and impact energy, industrial, and consumer markets. In particular, the present disclosure provides for the development of high temperature, high strength, corrosion resistant tubing components that can be used in system using supercritical CO₂ (s-CO₂) Brayton cycle, where the cycle temperatures are greater than 600° C. and pressures up to 25 MPa.

Coating the inner surface of long and narrow tubes is very difficult and is typically limited to a length of about twice the inner diameter of the tube. The present disclosure provides for methods of coating the inner surface of long and narrow tubes using additive manufacturing. In a particular aspect, the method can include using a Laser Engineered Net Shaping 3D printer (LENS system). The LENS system includes deposition of feedstock powders, sequentially or simultaneously, followed by irradiation with high power laser that fuses the powders into a dense three-dimensional structure. The method includes forming the tubing structure in a layer-by-layer manner (as described herein). In this way each layer of the tubing component can be simultaneously synthesized and processed to form a protective coating along with its inner tube wall (e.g., Mo tube wall). Since the printer uses multiple feed hoppers, the core tube material (e.g., Mo) and the protective inner and outer coating (e.g., Mo—Si—B) can be deposited together to form a highly coherent interface between the materials. In other words, the inner and outer layers can be formed will also form the tubing wall along its longitudinal axis. Once the tubing component is formed in an iterative step-by-step process, the green body tubing component can be fired in air to form a borosilicate layer on the inner and outer layers.

Now having described the present disclosure generally, additional details are provided. The present disclosure provides for a tubing component that includes a Mo tube wall (e.g., circular cross-section). The Mo tube wall has an inside surface and an outside surface, where the inside surface defines the space inside the tubing component and the outside surface is on the exterior side of the tubing component. An inner coating is on the inside surface of the Mo tube and an outer coating on the outside surface of the Mo tube.

The tubing component can be straight or substantially straight and/or can include curved portions, right angles, and other contours present in tubing components. In some instances, the tubing component (e.g., union, an elbow, coupling, or a valve) can include complicated dimensions, but the methods of the present disclosure form the Mo tube wall and the inner and outer coatings (e.g., non-circular cross-sections). Dimensions of the Mo tube are only limited by the 3D printer's capabilities. In one embodiment, the Mo tube wall can have a wall thickness of about 1 to 10 mm or about 2 to 5 mm. The tubing component can have an outer diameter of about 3 mm to 500 mm. The Mo tube length can depend on the specific receiver configuration. A typical Mo tube length can be about 2 to 6 meters. In an aspect, the length can be about 10 mm to 1 m or more. In more complicated tubing components, the dimension can be from on the cm to m scale and will depend upon the specific component.

The inner coating can have a thickness of about 10 to 150 μm, about 10 to 100 μm, or about 10 to 75 μm. The outer coating can have a thickness of about 10 to 150 μm, about 10 to 100 μm, or about 10 to 75 μm. The thickness of the inner coating and the outer coating can be the same or different.

In an aspect, the inner coating comprises a MoSiB inner coating, while the outer coating includes a MoSiB outer coating. The MoSiB inner coating is adjacent the inner surface of the Mo tube wall. The MoSiB outer coating is adjacent the outer surface of the Mo tube wall. The MoSiB inner coating and the MoSiB outer coating can have the same thickness or a different thickness. Due to the method of making the tubing component, the Mo tube wall and the MoSiB inner and outer coatings are monolithic and integral to one another, thereby have outstanding characteristics such as those described herein.

In another aspect, the inner coating comprises a MoSiB inner coating and SiO₂Bₓ inner coating, while the outer coating includes a MoSiB outer coating and SiO₂Bₓ inner coating (x<1 weight %, in an aspect x is greater than 0 and less than 1 weight %). The MoSiB inner coating has a first side and a second side. The first side of the MoSiB inner coating is bonded to the inside of the Mo tube and the SiO₂Bₓ inner coating is bonded to the second side of the MoSiB inner coating so that the SiO₂Bₓ inner coating is the inner most layer of the tubing component. The MoSiB outer coating has a first side and a second side. The first side of the MoSiB outer coating is bonded to the outside of the Mo tube and the SiO₂Bₓ outside of the coating is bonded to the second side of the MoSiB outer coating so that the SiO₂Bₓ outer coating is the outer most layer of the tubing component. The MoSiB inner coating and the MoSiB outer coating can have the same thickness or a different thickness. The SiO₂Bₓ inner coating and the SiO₂Bₓ outer coating can have the same thickness or a different thickness. Due to the method of making the tubing component, the Mo tube wall, the MoSiB inner and outer coatings, and the SiO₂Bₓ inner and outer coatings are monolithic and integral to one another, thereby have outstanding characteristics such as those described herein.

The MoSiB inner coating can have a thickness of about 10 to 120 μm, about 20 to 80 μm, or about 30 to 60 μm. The MoSiB outer coating can have a thickness of about 10 to 120 μm, about 20 to 80 μm, or about 30 to 60 μm. The SiO₂Bₓ inner coating can have a thickness of about 5 to 20 μm, about 5 to 15 μm, or about 10 μm. The SiO₂Bₓ outer coating can have a thickness of about 5 to 20 μm, about 5 to 15 μm, or about 10 μm.

The present disclosure provides for a tubing component that has the characteristic of being stable (e.g., resistant to oxidation and phase change) at about 700° C. to 1650° C. or 700° C. to 1300° C.

The present disclosure provides for a tubing component that has the characteristic of handling (e.g., unreactive or inert to sCO₂) sCO₂, wherein the SCO₂ is at a temperature of about 700° C. to 1650° C. or 700° C. to 1300° C.

The present disclosure provides for a tubing component a tensile strength of about 100 Mpa to 140 Mpa at about 1200° C., or a tensile strength of 124 about MPa at 1200° C.

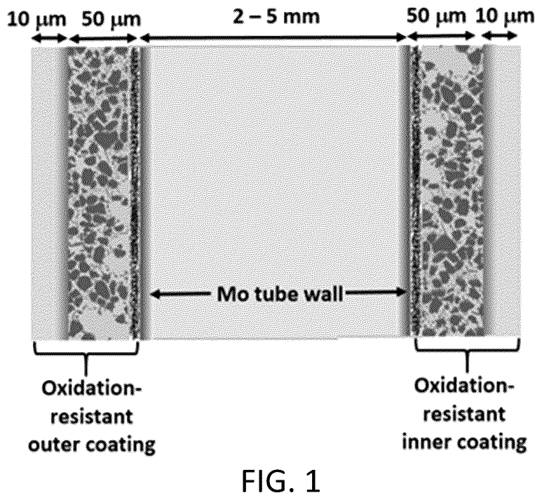

FIG. 1 illustrates an exemplary embodiment of a portion of tubing component that includes a single Mo wall and coating layers. FIG. 1 is a cross-sectional view of a coated surface of a receiver tube wall with Mo—Si—B coating (═SiO₂Bₓ outer layer+composite middle layer); and refractory metal, such as Mo (substrate). All substrate surfaces exposed to air will be coated (e.g., inner and outer walls of absorber tubes).

The present disclosure also provides for methods of making the tubing component. The method provides for the additive manufacturing of the tubing component. For example, a LENS system can be used to form the tubing component. In an aspect, the method includes making a tubing component by disposing one or more different precursor materials (sequentially or simultaneously) to form a layer (e.g., a thickness of about 3 mm to 500 mm, depending on the application and printer capabilities) corresponding to the cross-sectional dimensions of tubing component. The layer of material(s) can be irradiating to form a first layer of the tubing component. The layer of precursor material(s) can be irradiated after the layer of material(s) are formed or simultaneously as the layer of precursor material is disposed on a surface. This can be repeated in a layer-by-layer manner until the tubing component is formed. Once the tubing component is formed, it can be subject to a high-temperature firing at a temperature of about 1200° C. to 1500° C. to form the tubing component having a Mo tube wall, MoSiB inner coating, and MoSiB outer coating. The SiO₂Bₓ inner coating, and SiO₂Bₓ outer coating as described herein, may require a separate firing cycle in air to promote formation of the oxidation-resistant scale.

In addition, the method includes selection of independently adjustable parameters including laser power, repetition rate, powder feed rate, precursor material morphology (e.g., powder morphology), and nozzle design. These parameters can be set based on precursor material melting temperature, thermal conductivity, heat capacity, and chemical reactivity. These parameters can be adjusted as needed based on the tubing component to be made and materials used to make the tubing component.

In an aspect, the method includes: a) disposing a first material in a first area, where the first material is a precursor material to form Mo (e.g., Mo powder); b) disposing a second material in a second area, where the first area and second area are adjacent another, where the second material is a precursor to form MoSiB (e.g., Mo₅Si₃Bₓ powder); c) disposing a third material in a third area, where the third area is on a side of the first area opposite the second material, where the third material is a precursor to form MoSiB. The first area, the second area, and the third area form a cross-section for a first layer of the tubing component, where the second area is on an inner side of the first layer of the tubing component, where the third area is on an outer side of the first layer of the tubing component. The precursor materials to form Mo and MoSiB be delivered from independent dispensers. For example, one dispenser can dispense a Mo precursor material such as molybdenum powder, while a second dispenser can dispense Mo₅Si₃Bₓ powder. For the first area, the precursor material dispensed can be Mo precursor. For the second area, the precursor material dispensed can be Mo₅Si₃Bₓ powder. In another aspect, the first dispenser and the second dispenser can dispense an amount of each of the Mo precursor and the Mo₅Si₃Bₓ powder so that blend the two precursors to form a gradient from the first area to the second area, which may produce better adhesion among the components.

The first layer can be irradiated (e.g., using a laser) to form a first Mo tube wall layer, an inner coating layer, and an outer coating layer. The inner coating layer is on the inside of the Mo tube layer and an outer coating layer is on the outside of the Mo tube layer. The inner coating layer comprises a MoSiB inner coating layer and the outer coating includes a MoSiB outer coating layer. The irradiation can be performed simultaneously as the precursor materials are dispensed or after the precursor materials are dispensed.

Next a second layer can be formed on top of the irradiated first layer. The same or a similar procedure is performed depending upon the dimensions of the tubing component to be formed (e.g., dimensions may change based on the three-dimension structure of the tubing component.

A third layer, a fourth layer, a fifth layer, etc. can be formed once the preceding layer is irradiated. The number of layers can be 100s to 1000s to 10000s or more depending on the size of the tubing component. Each layer can have a thickness of about 20 microns to 150 microns.

Once the MoSiB inner coating layer and the MoSiB outer coating layer (or the precursor materials thereof are disposed) are formed, a precursor material for a SiO₂Bₓ inner coating layer (e.g., where is x is <1 wt. %, in an aspect x is greater than 0 and less than 1 weight %) can be disposed adjacent the MoSiB inner coating layer and the MoSiB outer coating layer (or the precursor materials thereof are disposed). The precursor material for a SiO₂Bₓ on inner coating layer and the precursor material for a SiO₂Bₓ on inner coating layer can be irradiated as described above and herein. The irradiation step can be performed for all precursor materials at once or sequentially.

Once the structure for the tubing component is formed, it can be subjected to high-temperature firing (e.g., in a furnace) to form the final product of the tubing component having a Mo tube wall, MoSiB inner coating, MoSiB outer coating, SiO₂Bₓ inner coating, and SiO₂Bₓ outer coating as described herein.

The Mo power can be made of spherical or non-spherical particles having dimensions of about 40 to 150 microns or about 45 microns. In an aspect the dimensions of the particles are very similar to one another, for example, all of the particles can have a diameter in the range of about 40 to 50 microns. Similarly, the Mo₅Si₃Bₓ powder can be made of spherical or non-spherical particles having dimensions of about 40 to 150 microns or about 45 microns. In an aspect the dimensions of the particles are very similar to one another, for example, all of the particles can have a diameter in the range of about 40 to 50 microns.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

We claim:

1. A tubing component, wherein the tubing component comprises a Mo tube wall having an inner coating on the inside of the Mo tube and an outer coating on the outside of the Mo tube, wherein the inner coating comprises a MoSiB inner coating, wherein the outer coating includes a MoSiB outer coating.

2. The tubing component of claim 1, wherein the Mo tube wall as a thickness of about 1 to 10 mm, wherein the inner coating has a thickness of about 10 to 150 μm, wherein the outer coating has a thickness of about 3 mm to 500 mm.

3. The tubing component of claim 2, wherein the inner coating further comprises a SiO₂Bₓ inner coating, wherein is x<1 weight % and x>0, wherein the MoSiB inner coating has a first side and a second side, wherein the first side of the MoSiB inner coating is bonded to the inside of the Mo tube and the SiO₂Bₓ inner coating is bonded to the second side of the MoSiB inner coating so that the SiO₂Bₓ inner coating is the inner most layer of the tubing component; and
wherein the outer coating further comprises a SiO₂Bₓ outer coating, wherein is x is <1 wt. % and x>0, wherein the MoSiB outer coating has a first side and a second side, wherein the first side of the MoSiB outer coating is bonded to the outside of the Mo tube and the SiO₂Bₓ outer coating is bonded to the second side of the MoSiB outer coating so that the SiO₂Bₓ outer coating is the outer most layer of the tubing component.

4. The tubing component of claim 3, wherein the MoSiB inner coating has a thickness of about 10 to 100 microns, wherein the MoSiB outer coating has a thickness of about 10 to 100 microns, wherein the SiO₂Bₓ inner coating has a thickness of about 5 to 20 microns, wherein the SiO₂Bₓ outer coating has a thickness of about 5 to 20 microns.

5. The tubing component of claim 4, wherein the length of the tubing component is greater than the diameter of the tubing component.

6. The tubing component of claim 4, wherein the length of the tubing component about 10 mm to 6 m.

7. The tubing component of claim 1, wherein the tubing component is straight.

8. The tubing component of claim 1, wherein the tubing component comprises a union, an elbow, coupling, or a valve.

9. The tubing component of claim 1, wherein the tubing component is stable at about 700° C. to 1300° C.

10. The tubing component of claim 1, wherein the tubing component has the characteristic of handling sCO₂, wherein the SCO₂ is at a temperature of about 700° C. to 1300° C.

11. The tubing component of claim 1, wherein the tubing component has a tensile strength of about 100 Mpa to 140 Mpa at 1200° C.

12. A method of making a tubing component, comprising:
a) disposing a first material in a first area, wherein the first material is a precursor material to form Mo;
b) disposing a second material in a second area, wherein the first area and second area are adjacent another, wherein the second material is a precursor to form MoSiB;
c) disposing a third material in a third area, wherein the third area is on a side opposite the second area, wherein the third material is a precursor to form MoSiB, wherein the first area, the second area, and the third area form a cross-section for a first layer of the tubing component, wherein the second area is on an inner side of the first layer of the tubing component, wherein the third area is on an outer side of the first layer of the tubing component;
d) irradiating the first layer to form a first Mo tube wall layer, an inner coating layer, and an outer coating layer, wherein the inner coating layer is on the inside of the Mo tube layer and an outer coating layer is on the outside of the Mo tube layer, wherein the inner coating layer comprises a MoSiB inner coating layer, wherein the outer coating includes a MoSiB outer coating layer; and
e) repeating steps a) to c) to form the tubing component.

13. The method of claim 12, wherein any two or all three of steps a), b), and c) are performed simultaneously or sequentially, optionally wherein steps a), b), c), and d) are performed simultaneously.

14. The method of claim 13, wherein the inner coating further comprises a SiO₂Bₓ inner coating layer, wherein is x is <1 wt. % and x>0, wherein the MoSiB inner coating layer has a first side and a second side, wherein the first side of the MoSiB inner coating layer is bonded to the inside of the Mo tube wall layer and the SiO₂Bₓ inner coating layer is bonded to the second side of the MoSiB inner coating layer so that the SiO₂Bₓ inner coating layer is the inner most layer of the tubing component.

15. The method of claim 12, wherein a laser engineered net shaping 3D printer is used to in steps a)-d).

16. The method of claim 15, wherein two or more dispensers are used to dispose the first material, the second material, and the third material.

17. The method of claim 15, wherein the irradiating is performed using a laser.

18. The method of claim 12, further comprising high-temperature firing of the tubing component under a temperature of about 1200° C. to 1500° C.

19. The method of claim 12, wherein the first layer has a thickness of about 20 microns to 150 microns.

20. The method of claim 12, wherein the tubing component formed comprises a union, an elbow, coupling, or a valve.
